(19) United States
(12) Patent Application Publication
(10) Pub. No.: US 2016/0172688 A1
(43) Pub. Date: Jun. 16, 2016

(54) BIPOLAR CURRENT COLLECTOR FOR LITHIUM-AIR BATTERY, METHOD FOR MANUFACTURING THE SAME, AND LITHIUM-AIR BATTERY INCLUDING THE SAME

(71) Applicant: HYUNDAI MOTOR COMPANY, Seoul (KR)

(72) Inventors: Won Keun KIM, Suwon-si (KR); Tae Young KIM, Suwon-si (KR); Na Ry SHIN, Seoul (KR); Kyoung Han RYU, Yongin-si (KR)

(21) Appl. No.: 14/951,346

(22) Filed: Nov. 24, 2015

(30) Foreign Application Priority Data
Dec. 12, 2014 (KR) 10-2014-0179398

(51) Int. Cl. H01M 8/02; C25D 11/26; H01M 12/08

(52) U.S. Cl. CPC H01M 8/0247; H01M 12/08; C25D 11/26; H01M 2300/0028

(57) ABSTRACT

A bipolar current collector for a lithium-air battery includes a substrate having a plate shape. A plurality of nanowires are anodized on the substrate and have a pillar shape with a predetermined height. An air path is formed between the plurality of nanowires and through which outside air flowing into a battery moves. The plurality of nanowires include titanium dioxide (TiO₂).

### CROSS-REFERENCE TO RELATED APPLICATION

This application claims under 35 U.S.C. §119(a) the benefit of priority to Korean Patent Application No. 10-2014-0179398 filed on Dec. 12, 2014, the entire content of which is incorporated herein by reference.

### TECHNICAL FIELD

The present disclosure relates to a bipolar current collector for a lithium-air battery, a method for manufacturing the same, and a lithium-air battery including the same. More particularly, the present disclosure relates to a bipolar current collector for a lithium-air battery including a substrate, titanium dioxide (TiO₂) nanowires, and an air path, and a method for manufacturing the same in order to provide a lithium-air battery having a small risk of failure, enhanced energy density per weight/per volume of the whole battery, and enhanced discharge capacity.

### BACKGROUND

Energy storage technologies for efficient energy as well as new and renewable energy have been developing rapidly due to environmental contamination with a continuous economic growth regarding depletion of fossil fuels, high oil prices, and the greenhouse effect.

A number of countries rely on other countries for energy and face a serious burden regarding greenhouse gas reduction obligation. As such, the countries face economic disadvantages such as environmental charges imposed when the obligation is not fulfilled.

Accordingly, developing the energy storage technologies for efficient energy use is considered as an important task influencing the future of many countries, and is expected to rapidly grow to a next-generation industry in terms of securing energy security by reducing energy reliance on foreign countries.

Therefore, developing technologies for a battery system having high energy density is necessary in order to solve the above problems. As one solution, the U.S. and Japan have been developing metal-air batteries.

A lithium-air battery has been developed, which uses lithium as an anode and oxygen in air as an active material of a cathode (air electrode). In the lithium-air battery, oxidation and reduction reactions of the lithium occur in the anode, and oxidation and reduction reactions of the oxygen occur in the cathode.

Referring the following Chemical Equations 1 and 2, a lithium metal of an anode is oxidized to produce lithium ions and electrons during a discharging reaction in a lithium-air battery, and the lithium ions move to a cathode through an electrolyte, and the electrons through an external conducting wire or a current collector. The oxygen included in outside air flows into a cathode, reduced by the electrons to form Li₂O₂. The charging reaction is progressed by a reaction opposite thereto.

(Anode): Li→Li⁺+e⁻ [Chemical Equation 1]

(Cathode): O₂+2Li⁺+2e⁻→Li₂O₂ [Chemical Equation 2]

A lithium-air battery unlimitedly receives oxygen in air thereby is capable of storing a large amount of energy through an anode having a large specific surface area, and has high energy density. The energy density of a lithium metal is 11140 Wh/kg, close to the energy density of gasoline and diesel fuels, and therefore, very high energy density may be obtained since the battery is operated by receiving light oxygen from outside. Theoretical energy density of a lithium-air battery is calculated to be 3500 Wh/kg, which is the highest among current next-generation secondary battery candidates, and this energy density is approximately 10 times higher than the energy density of lithium-ion batteries.

However, the energy density is an energy density value based on a weight of only an active material, and an energy density value with respect to the weight of the actual whole lithium-air battery significantly decreases. An energy density value with respect to the weight of an actual whole battery cannot be accurately calculated since a lithium-air battery is not completely commercialized and the battery design is not finalized, however, enhancing energy density by reducing the thickness and the weight of a lithium-air battery is certainly a most important technological challenge in a lithium-air battery field.

Existing lithium-air batteries use a graphite bipolar current collector for existing fuel cells. The bipolar current collector collects electrons generated from both cathode and anode, and also has a function of a path directing outside air when used in a lithium-air battery.

However, the graphite bipolar current collector has big difficulties process-wise in making an air path, and manufacturing a thin bipolar current collector has a limit due to problems such as strength, and consequently, a graphite bipolar current collector has a disadvantage in having big energy density loss per weight/per volume when used in a lithium-air battery since it is difficult to reduce the thickness and the weight.

In addition, a graphite bipolar current collector reacts with an organic electrolyte and may be corroded causing a failure, therefore, a solution for this problem has been necessary.

As an alternative for preventing corrosion, a bipolar current collector made of stainless steel has been tried, however, there is a limit in that energy density loss per weight becomes even bigger since a material itself has high density.

Accordingly, development of a current collector that does not corrode when adjoining an electrolyte, and is capable of enhancing energy density with respect to the total weight of the lithium-air battery by reducing a thickness and a weight has become an important technological challenge.

The above information disclosed in this Background section is only for enhancement of understanding of the background of the invention, and therefore, it may contain information that does not form the prior art that is already known in this country to a person of ordinary skill in the art.

### SUMMARY OF THE DISCLOSURE

The present disclosure has been made in an effort to solve the above-described problems associated with prior art, and an aspect of the present inventive concept provides a bipolar current collector for a lithium-air battery that is not corroded when reacted with an organic electrolyte.

Another aspect of the present inventive concept provides a bipolar current collector for a lithium-air battery capable of enhancing energy density per weight/per volume of a battery by reducing a thickness and a weight of the bipolar current collector, thereby reducing a weight and a volume of the whole battery.

Still another aspect of the present inventive concept provides a bipolar current collector for a lithium-air battery having an air path, thereby allowing smooth inflow of air and a cathode active material even when a battery cell is laminated.

The object of the present disclosure is not limited to the object described above, and those skilled in the art may clearly understand other object of the present disclosure not described above from the descriptions.

According to an exemplary embodiment of present inventive concept, a bipolar current collector for a lithium-air battery may include a substrate having a plate shape. A plurality of nanowires are anodized on the substrate and have a pillar shape with a predetermined height. An air path is formed between the plurality of nanowires and through which outside air flowing into a battery moves. The plurality of nanowires include titanium dioxide (TiO₂).

The TiO₂ nanowires may be anodized on and perpendicular to the substrate.

The bipolar current collector may have a thickness of 0.5 mm to 1.5 mm, and a weight of 15 g to 30 g.

According to another exemplary embodiment of the present inventive concept, a method for manufacturing a bipolar current collector for a lithium-air battery may include preparing a plurality of nanowires by anodizing with a constant current of 1 mA to 10 mA on a substrate for 30 minutes to 60 minutes in an electrolyte, and heat treating the plurality of nanowires.

The electrolyte may include ethylene glycol, 0.2 M to 1.0 M of hydrogen fluoride (HF), and 0.1 M to 1.0 M of hydrogen peroxide.

The plurality of nanowires may be heat treated for 3 hours to 7 hours at 300° C. to 500° C.

According to another exemplary embodiment of the present inventive concept, a lithium-air battery having a plurality of laminated battery cells. Each of the plurality of battery cells may include the bipolar current collector for a lithium-air battery, which comprises: a substrate having a plate shape; a plurality of nanowires anodized on the substrate and having a pillar shape with a predetermined height; and an air path formed between the plurality of nanowires and through which outside air flowing into a battery moves. A cathode is attached to the plurality of nanowires. An anode is attached to a substrate of a current collector of another battery. An electrolyte is disposed between the cathode and the anode. The plurality of nanowires include TiO₂.

The anode may be a lithium metal, the cathode is any one of a carbon-based material, a metal oxide-based material, and a precious metal-based material.

The electrolyte may be any one of a lithium salt-included ether-based solvent, a sulfone-based solvent, and a carbonate-based solvent.

Other aspects and exemplary embodiments of the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure.

FIG. 1 is a diagram showing a bipolar current collector for a lithium-air battery according to the present disclosure, and a method for manufacturing the same.

FIG. 2 is a diagram showing a cross section of a lithium-air battery according to the present inventive concept.

FIG. 3 is a graph measuring discharge capacity of lithium-air batteries manufactured in an example and a comparative example.

It should be understood that the appended drawings are not necessarily to scale, presenting a somewhat simplified representation of various features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to exemplary embodiments of the present inventive concept, examples of which are illustrated in the accompanying drawings and described below. While the inventive concept will be described in conjunction with exemplary embodiments, it will be understood that present description is not intended to limit the invention to those exemplary embodiments. On the contrary, the inventive concept is intended to cover not only the exemplary embodiments, but also various alternatives, modifications, equivalents, and other embodiments, which may be included within the spirit and scope of the invention as defined by the appended claims. In describing the examples of the present disclosure, detailed descriptions for known functions and constitutions are not included when it is decided that the detailed descriptions may unnecessarily cloud the gist of the present disclosure.

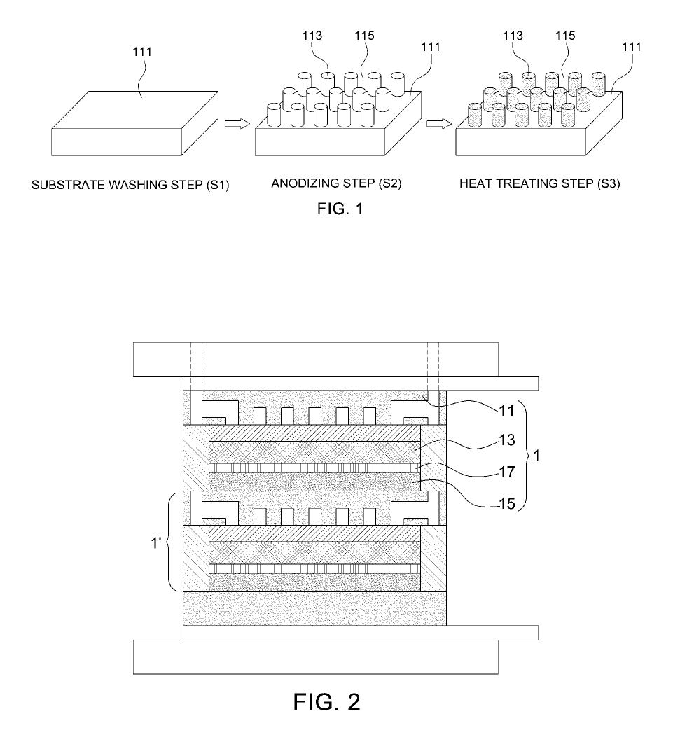

Referring to FIGS. 1 and 2, a bipolar current collector for a lithium-air battery according to the present disclosure (hereinafter, ‘a current collector’, 11) includes a plate-shaped substrate 111, a plurality of titanium dioxide (TiO₂) nanowires (hereinafter, ‘nanowires’, 113) formed by anodization on the substrate 111, and an air path 115 that is space formed between the nanowires 113.

The substrate 111 collects electrons generated by a reaction in a cathode and an anode, and a titanium substrate may be used. As will be described later, a nanowire layer may be formed on one surface of the substrate 111 by anodizing the substrate 111.

A nanowire is anodized on the substrate 111 in a pillar shape with a certain height, and a cylinder shape is shown in FIG. 1, however, the shape is not limited thereto, and the nanowire may have any pillar shape as long as the shape is capable of securing sufficient space to form the air path 115 with adjacent nanowires.

The nanowires 113 include titanium dioxide (TiO₂), and do not corrode when reacted with an electrolyte unlike existing current collectors, therefore, may enhance chemical stability of the current collector 11.

The nanowires 113 may be prepared by growing the titanium dioxide perpendicular or close to perpendicular to the substrate 111. Accordingly, the nanowire may be distributed by evenly arranging on the substrate 111, and the air path 115 may be distinctly formed. Therefore, air may be evenly encounter a cathode, and as a result, discharge capacity of a lithium-air battery may be enhanced.

The air path 115 is a space between the plurality of the nanowires 113, and performs a role of a path for outside air, which flows into the battery, moves. In the present disclosure, even when a battery cell is laminated, air, which is a cathode active material, may smoothly move through the air path 115 in a battery, and evenly encounters a cathode, therefore, discharge capacity of the battery may be enhanced.

In the current collector 11, a titanium substrate may be used as the substrate 111, and the nanowires 113 may be formed by anodizing titanium dioxide on the substrate 111. Therefore, problems of the existing lithium-air batteries described above may be solved since, due to the nature of a titanium material, the current collector i) does not corrode since it does not sensitively react with an electrolyte, and ii) has rigidity enough to be used in a lithium-air battery even when a weight and a thickness is reduced.

Referring to FIG. 1, a method for manufacturing a bipolar current collector for a lithium-air battery includes (1) step S2 of preparing the nanowires 113 through anodization by applying a constant current on the substrate 111 in an electrolyte, and (2) step S3 of heat treating the result of the first step.

In the manufacturing method described above, specific descriptions on the constituents such as a substrate and nanowires are the same as those described above, therefore, the descriptions are not repeated in order to avoid the repetition of descriptions.

The substrate 111 may additionally go through a washing process S1 prior to anodizing.

Specifically, step S2 may be carried out by forming a two-electrode electrochemical cell with a substrate, platinum, and an electrolyte. Using a two electrode system having platinum as an anode and a titanium substrate as a cathode, anodization may be carried out in an electrolyte that is a mixed liquid of ethylene glycol, 0.2 M to 1 M hydrogen fluoride (HF), and 0.1 M to 1.0 M hydrogen peroxide (H₂O₂).

Anodization may be carried out by applying a constant current of 1 mA to 10 mA for 30 minutes to 60 minutes.

In step S3, the nanowires 113 may be activated by heat treating the result of the first step for 3 hours to 7 hours at 300° C. to 500° C. as a post-treatment after completing the anodization.

Depending on the manufacturing condition of step S1 and step S2, the plurality of nanowires 113 in which titanium dioxide is anodized in a pillar shape perpendicular or close to perpendicular to the substrate 111 may be obtained on the substrate 111.

In step S1, a titanium substrate is used as a cathode. Accordingly, a width of the titanium substrate decreases by anodizing, and thus, a width of the current collector may be thinner than that of the titanium substrate.

A thickness of the current collector may be 0.5 mm to 1.5 mm. When the thickness is less than 0.5 mm, the collector may break easily. When the thickness is more than 1.5 mm, energy density of the battery system may decrease.

A weight of the current collector may be 10 g to 30 g. When the weight is less than 10 g, the collector may break easily. When the weight is more than 30 g, the energy density of the battery system may decrease.

Referring to FIG. 2, in a lithium-air battery according to the present disclosure, a battery cell 1 includes the current collector 11, a cathode 13, an anode 15, and an electrolyte 17 and is laminated (e.g., battery cells 1, 1′).

FIG. 2 shows a lithium-air battery in which the battery cell 1 is laminated in two layers, however, the lithium-air battery according to the present disclosure is not limited thereto, and may have a structure in which two or more layers of battery cells are laminated.

The battery cell 1 may have the current collector 11, the cathode 13, and the anode 15 laminated from an upper side, and the electrolyte 17 may be disposed between the cathode 13 and the anode 15 in the battery cell 1.

Detailed descriptions on the current collector are the same as the descriptions made above, and therefore, the descriptions are not repeated hereinafter in order to avoid the repetition of descriptions.

The current collector 11 may include a substrate surface (not shown), a smooth surface on which no nanowire grows, as one surface of the substrate, and a nanowire surface (not shown) on which nanowires grow, as another surface of the substrate.

The cathode 13 produces a reaction of Chemical Equation 2 when discharging a battery as described above, and may be located on a nanowire surface side of the current collector. Accordingly, air flowed in from the outside through the air path 115 may be directed to the cathode 13. The air, which is an active material, and electrons and metal ions (lithium ions) which are generated from the anode 15, may produce a reaction of Chemical Equation 2 in the cathode 13.

The cathode 13 may use a carbon-based, metal oxide-based, or precious metal-based material, or more specifically, may use a carbon-based based on a gas diffusion layer (GDL).

In the lithium-air battery according to the present disclosure, nanowires grow in an arranged structure on the substrate 111, and consequently, the air path 115 is well-developed as described above, therefore, the reaction of Chemical Equation 2 may smoothly occur in the cathode 13. As a result, discharge capacity of the lithium-air battery may be enhanced.

The anode produces a reaction of Chemical Equation 1 when discharging a battery as described above, and referring to FIG. 2, the anode may be attached to a substrate surface of the current collector 11 of another battery cell 1′ located on the lower side (a nanowire surface direction based on the current collector) of the battery cell 1.

The anode 15 may use a lithium metal, and or lithium metal foil.

The current collector 11 adjoins the cathode 13 included in the same battery cell through a nanowire surface, and adjoins the anode 15 included in another battery cell through a substrate surface, therefore, accepts electrons generated in the cathode and the anode, and as a result, may have a bipolar property.

As described above, the electrolyte is generally distributed over space occupied with a cathode and an anode, and therefore, is in contact with the current collector, and the current collector according to the present disclosure may not corrode when reacting with an electrolyte unlike existing current collectors since the current collector according to the present disclosure may be made of titanium materials.

The electrolyte may use any one of a lithium salt-included ether-based solvent, a sulfone-based solvent, and a carbonate-based solvent, or more specifically, tetraethylene glycol dimethyl ether (TEGDME), a solvent having the highest boiling point among ether-based solvents, may be used as the solvent, and LiTFSI, LiCF₃SO₃, LiI, LiPF₆ and the like may be used as the salt.

### EXAMPLES

Hereinafter, specific examples of the present disclosure will be provided. However, the examples described below are for illustrative or descriptive purposes only, and the scope of the present disclosure is not limited thereto.

### Example

### (1) Manufacture of Current Collector

1) A 0.8 mm titanium substrate was washed.

2) A two-electrode electrochemical cell was formed using the titanium substrate as a cathode, platinum as an anode, and a mixed liquid of ethylene glycol, 0.2 M to 1.0 M HF and 0.1 M to 1.0 M H₂O₂ as an electrolyte.

3) A constant current of 5 mA was applied for 60 minutes to carry out anodization.

4) A current collector was manufactured by heat treating the result for 5 hours at 400° C.

### (2) Manufacture of Lithium-Air Battery

1) A GDL-based carbon substrate was used as a cathode, and lithium metal foil was used as an anode, and an electrolyte was prepared by dissolving 1M LiTFSI in a TEGDME solvent as a lithium salt.

2) A battery cell, in which the current collector, the cathode and the anode were laminated from an upper side and the electrolyte was formed, was prepared, and the battery cell was laminated in two layers as in FIG. 2 to manufacture a 5 V grade lithium-air battery.

### COMPARATIVE EXAMPLE

A lithium-air battery was manufactured using the same constitutions and the same manufacturing method as in the example, except that a graphite bipolar current collector was used as the current collector as in existing technologies.

### Measurement Example 1

Physical properties of the current collector manufactured in the example were measured. The results are as shown in the following Table 1.

TABLE 1

| | Graphite | | |
|---|---|---|---|
| | (Comparative | Stainless | |
| | Example) | Steel | Example |
| Density (g/cc) | 2.09 | 8.03 | 4.23 |
| Thickness (mm) | 3.5 | 2.0 | 0.5²⁾ |
| Weight (g, 100 × 100 mm²) | 73.15 | 160.6 | 21.15 |
| Corrosion Resistance¹⁾ | X | ◯ | ◯ |

¹⁾Corrosion resistance means a property that is difficult to generate corrosion.
²⁾The thickness (height) of the current collector of the present invention was measured. In the process of manufacturing the current collector in which nanowires are formed by anodizing a titanium substrate with a thickness of 0.8 mm, the thickness decreases by 0.3 mm.

When referring to Table 1, the current collector according to the present disclosure is effective in reducing the thickness by approximately 85%, and the weight by approximately 71%.

### Measurement Example 2

Discharge capacity was evaluated by applying a constant current of 0.25 mA/cm² to the lithium-air batteries manufactured in the example and the comparative example.

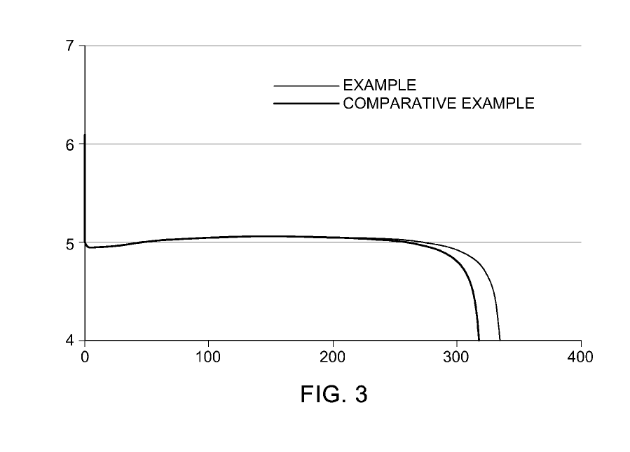

FIG. 3 is a graph showing a discharge curve of the lithium-air battery continuously discharged with a constant current, and referring to the graph, it was identified that the lithium-air battery of the example showed higher discharge capacity (approximately 330 mAh/cm²) compared to the lithium-air battery of the comparative example.

The present disclosure provides a current collector including a titanium substrate and titanium dioxide nanowires, therefore, is effective in providing a lithium-air battery in which the current collector is not corroded by an electrolyte, and energy density per weight/per volume of the whole battery is capable of being enhanced by reducing the thickness and the weight of the current collector.

In addition, the current collector of the present disclosure has a well-developed air path, therefore, is effective in providing a lithium-air battery having enhanced discharge capacity since air, which is a cathode active material, is capable of smoothly flowing into a cathode.

The bipolar current collector for a lithium-air battery as described above has the following effects.

The lithium-air battery of the present invention provides a small risk of failure since a current collector does not corrode by an electrolyte.

In addition, the lithium-air battery of the present invention provides enhanced energy density per weight/per volume of the whole battery by reducing the thickness and the weight of the current collector.

Moreover, the lithium-air battery of the present invention provides enhanced discharge capacity since air, which is a cathode active material, smoothly flows into a current collector.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A bipolar current collector for a lithium-air battery comprising:
a substrate having a plate shape;
a plurality of nanowires anodized on the substrate and having a pillar shape with a predetermined height; and
an air path formed between the plurality of nanowires and through which outside air flowing into a battery moves,
wherein the plurality of nanowires include titanium dioxide (TiO₂).

2. The bipolar current collector of claim 1, wherein the plurality of nanowires are anodized on and perpendicular to the substrate.

3. The bipolar current collector of claim 1, wherein the bipolar current collector has a thickness of 0.5 mm to 1.5 mm.

4. The bipolar current collector of claim 1, wherein the bipolar current collector has a weight of 15 g to 30 g.

5. A method for manufacturing a bipolar current collector for a lithium-air battery comprising:
preparing a plurality of nanowires by anodizing with a constant current of 1 mA to 10 mA on a substrate for 30 minutes to 60 minutes in an electrolyte; and
heat-treating the plurality of nanowires,
wherein the plurality of nanowires include TiO₂.

6. The method of claim 5, wherein the electrolyte includes ethylene glycol, 0.2 M to 1.0 M of hydrogen fluoride (HF), and 0.1 M to 1.0 M of hydrogen peroxide.

7. The method of claim 5, wherein in the heat-treating, the plurality of nanowires are heat-treated for 3 hours to 7 hours at 300° C. to 500° C.

8. A lithium-air battery having a plurality of laminated battery cells,
wherein each of the plurality of battery cells include: a bipolar current collector for a lithium-air battery,
the bipolar current collector comprising: a substrate having a plate shape; a plurality of nanowires anodized on the substrate and having a pillar shape with a predetermined height; and an air path formed between the plurality of nanowires and through which outside air flowing into a battery moves;
a cathode attached to the plurality of nanowires of the bipolar current collector;
an anode attached to a substrate of a bipolar current collector of another battery cell; and
an electrolyte disposed between the cathode and the anode,
wherein the plurality of nanowires include TiO₂.

9. The lithium-air battery of claim 8, wherein the anode is a lithium metal.

10. The lithium-air battery of claim 8, wherein the cathode is any one of a carbon-based material, a metal oxide-based material, and a precious metal-based material.

11. The lithium-air battery of claim 8, wherein the electrolyte is any one of a lithium salt-included ether-based solvent, a sulfone-based solvent, and a carbonate-based solvent.
